(19) United States
(12) Patent Application Publication
(10) Pub. No.: US 2026/0220718 A1
(43) Pub. Date: Jul. 30, 2026

(54) SYSTEM AND METHOD OF INVERSE IDENTIFICATION OF CAUSAL ASSETS AND PROCESSES

(71) Applicant: Honeywell International Inc., Charlotte, NC (US)

(72) Inventor: Quan Long, West Hartford, CT (US)

(21) Appl. No.: 19/039,794

(22) Filed: Jan. 29, 2025

(51) Int. Cl. G06Q 50/04; G06N 20/00; G06Q 10/0639

(52) U.S. Cl. CPC G06Q 50/04; G06N 20/00; G06Q 10/06395

(57) ABSTRACT

Various embodiments described herein relates to inverse identification of one or more causal assets and/or processes corresponding to a plurality of products in a flexible manufacturing environment. In this regard, routing data and quality notification data associated with the plurality of products is received. Further, the routing data and the quality notification data is correlated using the supervised machine learning (ML) model. As a result, at least one causal asset and/or at least one causal process is identified based on the correlation of the routing data and the quality notification data. Further, real-time recommendations including one or more corrective actions associated with the at least one causal asset and/or the at least one causal process are generated using the supervised ML model.

### TECHNICAL FIELD

The present disclosure is related to quality control and process optimization in a flexible manufacturing environment. More particularly, the present disclosure relates to inverse identification of causal assets and processes in a flexible shop floor.

### BACKGROUND

Typically, a shop floor is an area within a manufacturing facility where production and assembly processes take place. It's the operational hub where raw materials are transformed into finished products. The shop floor is equipped with various assets such as machines, tools, workstations and/or like tailored for specific manufacturing tasks. This includes equipment for cutting, assembling, molding, welding, painting, and packaging. The type and complexity of machinery may vary based on the products being manufactured. The shop floor usually encompasses multiple production processes, each representing a distinct stage in the manufacturing workflow. These processes might include material handling, machining, assembly, quality control, and finishing. A flexible shopfloor refers to a production environment where the layout and processes are adaptable and capable of being reconfigured to meet changing demands, product designs, or production requirements. The concept of flexibility in manufacturing aims to enhance the ability to respond quickly to market changes, customer demands, or unforeseen disruptions. Finished products on the flexible shop floor mostly get inspected after their manufacturing processes are completed. Installation of multiple in-process checkpoints to catch issues earlier in the production cycle may be time-consuming and expensive. This includes costs associated with additional equipment, increased labor, and potential disruptions to workflow. Also, sometimes it is not possible to install checkpoints after every step. Without installing extra in-process checkpoints, it is very difficult to identify the problematic processes and/or assets, which are associated to the quality problems. If defects are discovered post-production, tracing quality-issues of the final product backwards is very challenging in complex multi-processes operations. It could be time-consuming and may require extensive investigation. The inspection step itself may be labor-intensive and tedious. It often involves detailed assessments that may require specialized knowledge and tools. As a result, it may lead to delays in production and increase labor costs. Therefore, there is a need to identify specific manufacturing processes and/or assets that may lead to quality issues, especially when the raw materials pass through various assets and processes during manufacturing of the finished product.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments, in which:

FIG. 1 illustrates a schematic diagram illustrating a facility management system managing a plurality of facilities in accordance with one or more embodiments of the present disclosure;

FIG. 2 is a schematic diagram illustrating an exemplary facility of the plurality of facilities in accordance with one or more embodiments of the present disclosure;

FIG. 3 is a schematic diagram illustrating an implementation of a controller of a quality management system that may execute techniques in accordance with one or more embodiments of the present disclosure;

FIG. 4 is an exemplary block diagram illustrating an implementation of the quality management system within the facility management system in the facility, in accordance with one or more embodiments of the present disclosure;

FIG. 5 is an exemplary block diagram illustrating inverse learning of causal assets and/or processes in accordance with one or more embodiments of the present disclosure;

FIG. 6A is an exemplary block diagram illustrating a flexible shop floor in accordance with one or more embodiments of the present disclosure;

FIG. 6B illustrates an exemplary dataset used for training a supervised machine learning model in accordance with one or more embodiments of the present disclosure; and

FIG. 7 is a flowchart illustrating a method described in accordance with one or more embodiments of the present disclosure.

### SUMMARY

The details of some embodiments of the subject matter described in this specification are set forth in the accompanying drawings and the description below. Other features, aspects, and advantages of the subject matter will become apparent from the description, the drawings, and the claims.

In accordance with an embodiment of the present disclosure, a system for monitoring quality of a plurality of products in a flexible manufacturing environment is described herein. The system comprises at least one processor and a memory communicatively coupled to the at least one processor. The memory comprises one or more instructions which when executed by the at least one processor, cause the processor to receive routing data and quality notification data associated with the plurality of products, wherein the routing data indicates flow of raw material through a plurality of assets and a plurality of processes to manufacture the plurality of products in the flexible manufacturing environment, wherein the quality notification data indicates whether the plurality of products satisfies a predetermined quality standard, correlate, via a supervised machine learning (ML) model, the routing data and the quality notification data associated with each of the plurality of products, identify, via the supervised ML model, at least one causal asset from the plurality of assets based on the correlation of the routing data and the quality notification data, generate, via the supervised ML model, a first recommendation including one or more corrective actions associated with the at least one causal asset from the plurality of assets, and display, on a user interface of a display device, the first recommendation including the one or more corrective actions associated with the at least one causal asset.

In accordance with an example embodiment, a method for monitoring quality of a plurality of products in a flexible manufacturing environment is described herein. The method comprises receiving routing data and quality notification data associated with the plurality of products, wherein the routing data indicates flow of raw material through a plurality of assets and a plurality of processes to manufacture the plurality of products in the flexible manufacturing environment, wherein the quality notification data indicates whether the plurality of products satisfies a predetermined quality standard, correlating, via a supervised machine learning (ML) model, the routing data and the quality notification data associated with each of the plurality of products, identifying, via the supervised ML model, at least one causal asset from the plurality of assets based on the correlation of the routing data and the quality notification data, generating, via the supervised ML model, a first recommendation including one or more corrective actions associated with the at least one causal asset from the plurality of assets, and displaying, on a user interface of a display device, the first recommendation including the one or more corrective actions associated with the at least one causal asset.

The above summary is provided merely for purposes of providing an overview of one or more exemplary embodiments described herein so as to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained in the following description and its accompanying drawings.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### DETAILED DESCRIPTION

Reference will now be made in detail to embodiments, examples of which are illustrated in the accompanying drawings. In the following detailed description, numerous specific details are set forth in order to provide a thorough understanding of the various described example embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the particular feature, structure, or characteristic following the phrase may be included in at least one example embodiment of the present disclosure, and may be included in more than one example embodiment of the present disclosure (importantly, such phrases do not necessarily refer to the same example embodiment).

The word “exemplary” is used herein to mean “serving as an example, instance, or illustration.” Any implementation described herein as “exemplary” is not necessarily to be construed as preferred or advantageous over other implementations. If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some example embodiments, or it may be excluded.

One or more example embodiments of the present disclosure may provide an “Internet-of-Things” or “IoT” platform in a facility that uses real-time accurate models and visual analytics to monitor quality of one or more products in the facility. The IoT platform provides inverse identification of one or more causal assets and/or processes associated with the one or more products in the facility. The IoT platform is an extensible platform that is portable for deployment in any cloud or data center environment for providing an enterprise-wide, top to bottom view, displaying status of processes, assets, people, and/or safety. Further, the IoT platform of the present disclosure supports end-to-end capability to implement machine learning algorithms into a Quality Management System using real-time analytics.

Typically, a shop floor in a manufacturing facility serves as the operational hub where raw materials undergo transformation into finished products. It is the physical space where production and assembly activities take place, and it typically houses a variety of machines, tools, and workstations that are tailored to specific manufacturing tasks. These tasks might include operations such as cutting, welding, molding, painting, assembly, and packaging, each of which plays a critical role in the creation of the final product. The type of machinery and tools found on the shop floor varies significantly depending on the nature of the product being produced and the complexity of the manufacturing process. For instance, a facility that manufactures automotive parts might have large, specialized machines for casting and machining, while an electronics assembly plant might rely on intricate soldering stations and automated assembly lines.

In the flexible shop floor, the production process is typically divided into several stages. These stages are designed to handle different aspects of manufacturing, with each stage involving a specific set of operations. Common stages in manufacturing workflows include material handling (the movement of raw materials into the production area), machining (where materials are shaped or cut to specific dimensions), assembly (where components are put together), quality control (ensuring that products meet specific standards), and finishing (where the product is completed, often including painting or packaging). These processes are usually interconnected, with products moving from one workstation to the next, undergoing various operations before being considered complete. Once the product reaches the final stages of production, it is typically inspected for quality to ensure it meets the required standards. This inspection process, however, can often be labor-intensive and detailed, requiring specialized knowledge, tools, and equipment. In some cases, the inspection process involves manual checks, which can be slow and prone to human error. Additionally, in large or complex manufacturing operations, the sheer number of products being produced and the diversity of tasks involved can make quality control challenging. This becomes especially problematic when defects are identified after the product has been completed and shipped for further use or distribution.

In order to catch defects earlier in the manufacturing process, many facilities implement in-process checkpoints or quality controls at various stages of production. These checkpoints are designed to identify problems before they can propagate through the workflow, potentially leading to the production of faulty or defective products. However, installing these additional checkpoints can be costly and may disrupt the overall production process. Each checkpoint often requires specialized equipment, additional labor to monitor and assess product quality, and potentially more time to carry out inspections, all of which can increase operational costs. Moreover, the more checkpoints that are installed, the more likely there are to be bottlenecks or delays in production, particularly if the checkpoints require significant downtime or intensive manual labor.

Furthermore, it is not always possible to implement checkpoints at every stage of the production process, particularly in facilities where certain tasks or machines are highly specialized or difficult to monitor in real-time. As a result, quality issues may go unnoticed until later in the process, or even after the product has been completed. In complex, multi-stage manufacturing operations, identifying the source of a defect after production is especially difficult. Tracing the defect backward through the manufacturing process to find the root cause can be a time-consuming and resource-intensive task. It often involves a detailed investigation, requiring access to production logs, employee testimony, and sometimes even physical inspection of machines and tools used at earlier stages. This process can significantly delay production timelines and increase costs, as additional labor, equipment, and time are needed to conduct thorough investigations.

When defects are discovered post-production, it becomes even more challenging to identify which part of the process or which asset (e.g., machine, workstation, or raw material) caused the problem. Without adequate in-process quality checks, there is a significant risk that the issue may be traced back to a particular stage or piece of equipment only after considerable investigation. This can further extend production timelines and result in higher labor and operational costs, as it may be needed to devote significant resources to uncovering the root cause of the defect. Additionally, without effective quality control during the production stages, there is an increased risk that the final inspection may be the only opportunity to catch issues, and even then, not all defects are easily identifiable.

To overcome some of these limitations, manufacturers have increasingly turned to predictive techniques that allow for early identification of potential quality issues. One such technique is virtual metrology, which attempts to predict the quality of products without directly measuring them. Instead, virtual metrology relies on indirect measurements such as sensor data, physical measurements, and process parameters to estimate the final product's quality.

Virtual metrology is a concept where predictive models are employed to estimate or predict the outcome of a quality test without physically testing the product. These models use data derived from various process parameters such as temperature, pressure, humidity, speed, or even sensor readings from machines and workstations, to infer the quality of the final product. Essentially, the virtual metrology acts as a virtual sensor that estimates the quality of products based on the real-time monitoring of machine performance and environmental conditions. In this context, the key idea behind virtual metrology is that there is a predictable relationship between the operating conditions of the production process and the quality of the final product. For example, if a certain temperature range or pressure is required for a particular material to reach its optimal quality state, virtual metrology would help estimate whether the product will pass or fail based on these parameters.

Virtual metrology often involves the use of machine learning (ML) algorithms to analyze and build relationships between the various process parameters and quality outcomes. By training models on historical data such as past production runs, process measurements, and quality results, these models can learn how different parameters affect product quality. The machine learning model then uses this information to make predictions for new, incoming data. For instance, if a process parameter such as temperature is recorded during the manufacturing of a product, the model can predict the product's quality based on the relationship it has learned from previous data. However, while virtual metrology can be very effective at predicting quality outcomes, it has some inherent limitations. Virtual metrology uses physical process data and anomaly detection algorithms in predicting abnormal quality results. However, use of physical process data is more costly because it requires installation of sensors in extreme environment, e.g., high temperature/high pressure.

Most notably, traditional virtual metrology models do not consider the complete path that materials take through the manufacturing process, nor do they incorporate the specific assets or machines used at each stage. One of the key shortcomings of traditional virtual metrology systems is that they typically ignore the routing data. Routing data refers to the detailed information about the path materials follow through the production process including the specific machines and workstations involved at each step of the manufacturing process. For instance, in the flexible manufacturing environment, raw materials may go through different machines (assets) in a particular sequence depending on factors like material type, production batch, or order. This missing piece of data is important because the specific sequence of operations and assets that a product passes through can have a significant impact on its final quality. Different machines might apply varying forces or conditions, and the combination of assets used could affect the product quality in ways that are not captured solely by process parameters like temperature or pressure. For example, a raw material passing through a certain machine may be subjected to a different stress or force than if it had passed through another machine, even if the process parameters were otherwise identical.

Without routing data, virtual metrology models are limited to analyzing individual process parameters without considering how different machines and workstations interact in the production process. This can result in missed correlations or incomplete insights into why certain products fail quality inspections. For example, a failure could be caused by a specific machine or a particular process that is not fully accounted for in traditional virtual metrology models. While traditional virtual metrology models have advanced in terms of predicting quality outcomes based on process parameters, they do not provide a comprehensive view of the manufacturing process. They typically lack the ability to trace the flow of materials through different processes and assets, which is critical to accurately identifying the root causes of quality failures.

Therefore, there is a need to identify specific manufacturing processes and/or assets that may lead to quality issues, especially when the raw materials pass through various assets and processes during manufacturing of the finished product. The present invention facilitates monitoring of quality concerns related to the manufacturing processes and assets in the flexible shop floor using a multi-process Explainable Artificial Intelligence (AI) analysis based on a supervised machine learning (ML) model. According to the present invention, the supervised machine learning model learns and/or uses relationship between routing data and quality notification data and accordingly, generates a forward map between the routing data and the quality notification data to identify problematic assets and/or processes effectively. Further, the present invention facilitates generation of one or more recommendations corresponding to the problematic assets and/or processes and provide one or more corrective actions.

According to an aspect of the present invention, the routing data serves as a comprehensive map of the production process, outlining the path and sequence of operations that raw materials undergo as they pass through various assets (machines or workstations). Each routing path represents a unique trajectory that the materials take, enhancing clarity of the production flow and aiding in quality control. The present invention utilizes the routing data from Enterprise Resource Planning (ERP) or Enterprise Data Warehouse (EDW) systems to monitor and track the flow of materials through the manufacturing process. This allows for a comprehensive view of how raw materials progress through various manufacturing stages. The routing data outlines the specific steps, resources, and machinery required to transform raw materials into finished products. There are a plurality of manufacturing processes and a plurality of assets in the flexible shop floor. The plurality of assets may include machines and/or work centers. The plurality of assets may be required to process the raw material into the finished products via the plurality of manufacturing processes.

According to another aspect of the present invention, the quality notification data indicates quality measurements and inspection results. The quality notification data includes a quality notification that describes non-conformance with a quality requirement. The quality notification may be categorized into two primary outcomes: “pass” or “fail”. When a quality notification results in a “pass,” it indicates that the inspected product, process, or batch meets the established quality standards and specifications. A “fail” notification indicates that the product or process did not meet the required quality standards. This could involve defects, deviations, or non-conformances that could affect product performance or safety. Additionally, the quality notification data often contains requests for appropriate corrective actions, ensuring that any identified issues are promptly addressed to maintain quality standards and improve overall production processes.

According to another aspect of the present invention, by correlating the routing data and the quality notification data using the supervised ML model, the Quality Management System may effectively trace back to the specific processes or assets responsible for any defects. The supervised machine learning model learns and/or uses relationship between routing data and quality notification data and accordingly, generates a forward map between the routing data and the quality notification data to identify problematic assets and/or processes effectively. This identification of the exact point of failure allows for targeted corrective actions, such as adjusting asset settings or refining operational processes. The supervised ML model is constructed to establish a relationship between the routing data and the corresponding quality notification data. In an example, the supervised ML model such as XGBoost (gradient-boosting decision tree) processes input variables such as continuous variables and discrete variables. Continuous variables may take any value within a range and are often measured rather than counted. For instance, continuous variables may include material thickness, recycling percentage, and/or like. Discrete variables consist of distinct values that can be counted. For instance, the assets in the manufacturing process are discrete variables. Each asset represents a specific machine or workstation involved in the production. Once a dataset that includes both discrete and continuous variables is compiled, a comprehensive table is created that serves as input for the supervised ML model. This table would typically include discrete and continuous variables. The present invention may use the XGBoost to train the supervised ML model, where the target variable is the binary inspection result (“1” and “0”, where “1” is represented as “pass” and “0 ” is represented as “fail”).

According to another aspect of the present invention, the use of the multi-process Explainable AI analysis allows the supervised ML model to relate identified quality issues directly to the specific processes or assets involved. For instance, feature importance or the SHAP values may be used to interpret the output of the supervised ML model. SHAP values provide a clear framework to understand the contribution of each feature (input variables) to the model's predictions. SHAP values provide clarity on how each input feature (e.g., asset type, process parameters, material properties) influences the prediction of quality outcomes. This helps identify critical factors that contribute to quality failures. Each SHAP value quantifies the impact of a specific feature on the prediction. A positive SHAP value indicates that the feature increases the likelihood of the prediction, while a negative SHAP value indicates that the feature reduces the likelihood of the prediction. This model also learns from historical data, enabling it to predict potential quality issues based on the routing paths. By leveraging the multi-process Explainable AI analysis like considering feature importance and SHAP values, the present invention may effectively identify which assets in the routing are most influential with respect to quality notifications and additionally determines the potential reasons for the specific quality notification, enabling more informed decision-making and improved quality control. This insight allows for targeted interventions, such as optimizing specific assets or adjusting material properties to enhance product quality.

According to another aspect of the present invention, for model creation with XGBoost, the dataset is split into training dataset and testing dataset, typically using 80% for training the model and 20% for testing the model's performance. During the training phase, the model learns to map the features (discrete and continuous variables) to the binary inspection results. During the testing phase, the model's performance is evaluated based on the testing dataset. A high accuracy indicates that the model effectively predicts the inspection outcomes. The Accuracy of the model is determined using the formula: Accuracy=Number of Accurate Predictions/Total Number of Predictions. If the accuracy meets the predetermined threshold, the present invention proceeds with further analysis. If not, the features may be re-evaluated by collecting more data.

According to another aspect of the present invention, Perturbation Importance is used to assess the sensitivity of the model based on changes in feature values. For each feature, values in the testing dataset are temporarily shuffled and the decrease in the accuracy of the model is evaluated. The greater the drop in accuracy when the specific feature is shuffled, the more important that feature is to the model. This approach provides insights into which variables have the most significant influence on the model's predictions, helping prioritize focus areas for quality improvement. Further, to evaluate the importance of each feature in the dataset using perturbation importance, the model is trained on the original dataset and then the predictions are obtained for the testing dataset and the model's accuracy is being calculated. Further, for each feature in the dataset, the values of that feature are shuffled or randomized in the testing dataset. This disrupts the relationship between that feature and the target variable while keeping other features intact. The model predictions are re-evaluated on the perturbed test dataset and the new accuracy is calculated based on these predictions. The difference in accuracy is being calculated between the original model predictions and the perturbed predictions. A larger difference indicates that the feature is sensitive and has a strong influence on the model's performance. Conversely, if the difference is small, the feature may have a minimal impact on the predictions. For features related to specific assets, it may be identified which assets are associated with the most sensitive features. This helps in pinpointing which assets may be critical in influencing quality outcomes. Therefore, by comparing the accuracy of the original model with that of the perturbed dataset, the sensitivity of each feature may be determined. Features that cause significant changes in accuracy when perturbed are deemed important for the model's predictions. This method provides valuable insights into the relationships between assets and quality outcomes, allowing for targeted improvements in manufacturing processes. If the perturbed feature corresponds to an asset or a specific process parameter, it may indicate that problems related to that asset or parameter are critical to understanding quality issues. For example, if material thickness shows a large sensitivity, it may warrant closer monitoring or adjustments in manufacturing processes related to material handling. Also, by identifying which features are most influential, quality improvement efforts may be prioritized on those areas that have the potential to yield the most significant impact on overall product quality.

According to another aspect of the present invention, the sub-system or sub-process parameters such as temperature, pressure, humidity, and/or like are analyzed specifically for the assets and/or processes that have been identified as problematic. In other words, the present invention selectively analyzes environmental or operational factors (e.g., temperature, pressure, humidity) for only those assets and/or processes that have been flagged as problematic. This approach ensures that the focus is on the areas of the manufacturing process that are most likely to be causing issues, rather than analyzing all parameters across the entire system. Further, in an embodiment, as new data enters the system, it may immediately be processed to identify and address issues. This allows for rapid detection and resolution of any emerging problems during the manufacturing process.

According to another aspect of the present invention, a user interface is provided to visualize key performance indicators (KPIs) of the manufacturing processes. In one embodiment, the user interface is a cloud-based user interface that displays a real-time analytics dashboard. In an embodiment, the user interface may display one or more causes of quality issues associated with one or more causal assets/processes. In another embodiment, the user interface may display one or more recommendations including one or more corrective actions. In some instances, the user interface provides real-time updates on quality results. The user interface allows operators to monitor the KPIs using line charts, bar charts, and/or like to understand quality of one or more intermediate and/or final products. Further, the user interface allows operators to view detailed logs, investigate incidents, and take one or more corrective actions. Display of the user interface can be interpreted by engineers and corrective actions can be timely performed by operators. For example, the display may be of a mobile device associated with personnel in the facility.

Therefore, instead of merely predicting whether a product will pass or fail, the present invention seeks to trace back to the exact processes or assets responsible for quality failures. The present invention can identify the key processes and causal factors without instrumenting extra check points in a shopfloor value stream. This enables a deeper understanding of the underlying causes of defects. By identifying problematic processes and assets, proactive measures could be taken to address issues before they result in failed inspections. This helps in mitigating risks and improving overall quality. Incorporation of routing information allows for a detailed analysis of how different pathways and assets interact in the manufacturing process. This provides context to the quality issues, making it easier to pinpoint where interventions are needed. Understanding the specific assets or processes associated with quality problems allows for targeted corrective actions, such as optimizing asset settings, refining processes, or addressing material handling issues. This inverse analysis enables deeper insights into quality issues, facilitating proactive measures that lead to enhanced quality management and continuous improvement in manufacturing processes.

Therefore, various examples of systems and methods described herein relate to monitoring quality of a plurality of products in a flexible manufacturing environment. In this regard, various example embodiments described herein facilitate the Quality Management System to inversely identify problematic assets and/or processes using the multi-process Explainable AI analysis based on the supervised ML model. Per this aspect, the systems and methods described herein receive routing data associated with the plurality of products from Enterprise Resource Planning (ERP) or Enterprise Data Warehouse (EDW) systems. Further, the systems and methods described herein receive quality notification data associated with the plurality of products. The routing data indicates flow of raw material through a plurality of assets and a plurality of processes to manufacture the plurality of products in the flexible manufacturing environment. The quality notification data indicates whether the plurality of products satisfies a predetermined quality standard. Further, various example embodiments described herein correlate, via a supervised machine learning (ML) model, the routing data and the quality notification data associated with each of the plurality of products. Further, various example embodiments described herein identify, via the supervised ML model, at least one causal asset from the plurality of assets based on the correlation of the routing data and the quality notification data. Further, various example embodiments described herein generate, via the supervised ML model, a first recommendation including one or more corrective actions associated with the at least one causal asset from the plurality of assets. Further, various example embodiments described herein display, on a user interface of a display device, the first recommendation including the one or more corrective actions associated with the at least one causal asset. Further, various example embodiments described herein identify, via the supervised ML model, at least one causal process from the plurality of processes based on the correlation of the routing data and the quality notification data. Further, various example embodiments described herein generate, via the supervised ML model, a second recommendation including one or more corrective actions associated with the at least one causal process from the plurality of processes. Further, various example embodiments described herein display, on the user interface, the second recommendation including the one or more corrective actions associated with the at least one causal process.

Further, various example embodiments described herein translate the relationship between the routing data and the quality notification data into understandable insights and recommendations. In one example, the insights may be related to operational insights. In yet another example, the insights may be related to identification of one or more causes of quality issues. In yet another example, the insights may be opportunities or corrective actions for improving the quality of the one or more products in the facility. The insights may be in the form of reports, trends, charts, graphs, and/or like so that the personnel even with minimal domain knowledge may understand and relate context of the insights. In some situations, the personnel may also apply their domain knowledge to additionally provide feedback on the insights rendered on the display so that the relevancy of insights may be improved. The aforementioned exemplary insights facilitate the systems and methods described herein to undertake relevant actions so as to efficiently improve the quality of the one or more products in the facility.

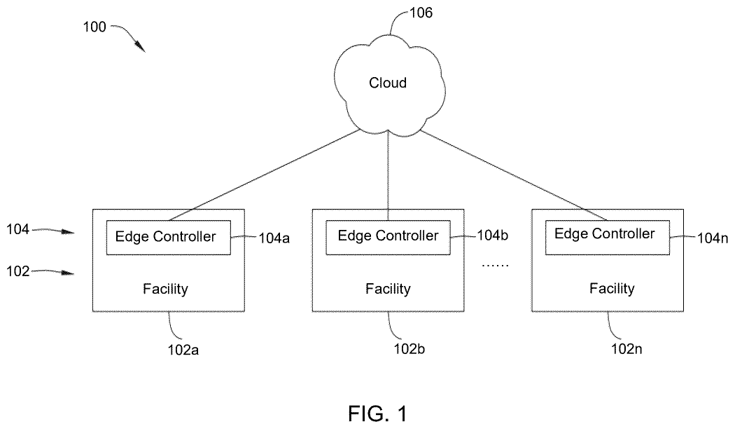

FIG. 1 illustrates a schematic diagram showing a facility management system 100 to manage multiple facilities in accordance with one or more example embodiments described herein. According to various example embodiments described herein, the exemplary facility management system 100 comprises one or more facilities 102a, 102b, . . . 102n (collectively “facilities 102”). In this regard, a facility of the one or more facilities 102a, 102b, . . . 102n may correspond to, for example, the flexible shop floor. The flexible shopfloor refers to a production environment where the production and assembly processes take place. The concept of flexibility in manufacturing aims to enhance the ability to respond quickly to market changes, customer demands, or unforeseen disruptions. This flexibility is achieved through various strategies, tools, and technologies. It's the operational hub where raw materials are transformed into finished products. The flexible shop floor could be, but not limited to, an industrial plant, a production plant, a manufacturing unit, an automotive industry, an electronics manufacturing unit, a food and beverage industry, a textile and apparel manufacturing unit, an aerospace manufacturing unit, a machine tool industry, an additive manufacturing unit such as 3D printing, a medical device manufacturing unit, and/or the like. For example, the aerospace manufacturing unit uses a flexible manufacturing system to produce various components for aircraft. This flexibility helps in handling different designs, accommodate customized orders, and manage low-volume production runs for different types of aircraft. In some example embodiments, the one or more facilities 102a, 102b, . . . 102n in the illustrative system 100 may be of same type. In some example embodiments, the one or more facilities 102a, 102b, . . . 102n in the illustrative system 100 may be of different type. As it may be understood, in some example embodiments described herein, each of the facilities 102 often include one or more assets tailored for specific manufacturing tasks. The “one or more assets” refer to the various physical components that are designed to handle a variety of tasks and products in the facility. Physical assets include modular workstations, machines, mobile equipment, tools, and/or like. This includes equipment for cutting, assembling, molding, welding, painting, and packaging. The type and complexity of machinery may vary based on the products being manufactured. Generally, the one or more assets are operated to handle one or more processes to manufacture one or more products in the facility 102. The shop floor usually encompasses the one or more processes such as manufacturing processes, each representing a distinct stage in the manufacturing workflow. The one or more processes might include material handling, machining, assembly, quality control, and finishing. In modern manufacturing systems, particularly flexible manufacturing environments (often called “flexible shop floor” or “smart factories”), raw materials pass through the one or more processes and the one or more assets before they become finished products. The facility management system 100 uses a variety of assets (e.g., machines, workstations) and processes, which are often connected through Enterprise Resource Planning (ERP) or Enterprise Data Warehouse (EDW) systems.

Further, in one or more example embodiments described herein, each of the one or more facilities 102a, 102b, . . . 102n includes a respective edge controller 104a, 104b, . . . 104n (collectively “edge controllers 104”). Per this aspect, the edge controller of the respective facility collects data associated with the one or more assets, the one or more processes, and the one or more products in the facility 102. In some example embodiments, the edge controllers 104 process the data received from the Enterprise Resource Planning (ERP) or the Enterprise Data Warehouse (EDW) systems. In this regard, the data may be related to routing data, quality notification data, and/or the like associated with one or more products manufactured in the facility 102. The routing data describes the path and sequence of operations that raw materials undergo as they pass through various manufacturing processes and assets (e.g., machines, workstations). The quality notification data indicates results of quality inspections based on whether the one or more products meet specific quality standards. In accordance with some example embodiments, one or more sensors are employed in the facility to sense the data associated with the one or more assets. In accordance with some example embodiments, the one or more sensors is communicatively coupled with the edge controller 104 of the facility 102. Accordingly, the edge controller 104 of the facility 102 receives the data associated with the one or more assets via the one or more sensors. In addition, in some example embodiments, the edge controllers 104 process the data received from the one or more sensors to derive insights associated with each of the one or more assets. Also, in some example embodiments, the edge controllers 104 may undertake one or more corrective actions to improve quality of intermediate and/or final products by optimizing the one or more assets and the one or more processes within the facility 102.

Further, in some example embodiments, the one or more facilities 102 may be operably coupled with a cloud 106, meaning that communication between the cloud 106 and the one or more facilities 102 is enabled. In some example embodiments, the one or more edge controllers 104 may be communicatively coupled to the cloud 106. The cloud 106 may represent distributed computing resources, software, platform or infrastructure services which may enable data handling, data processing, data management, and/or analytical operations on the data exchanged & transacted amongst the facilities 102. In accordance with some example embodiments, the data collected by the edge controllers 104 is uploaded to the cloud 106 for processing. Further, in accordance with some example embodiments, the cloud 106 processes data associated with the one or more assets, one or more processes, and the one or more products. In this regard, the cloud 106 also derives the insights associated with the data, and/or the like. Also, in some example embodiments, the cloud 106 may generate one or more opportunities and/or corrective actions based on the derived insights. Additionally, in some example embodiments, the cloud 106 may transmit the one or more opportunities and/or corrective actions to a respective edge controller of the one or more edge controllers 104 in the facility 102. Also, in some example embodiments, the cloud 106 may transmit the insights, the one or more opportunities, and/or corrective actions to a mobile device associated with the personnel in the facility.

In some example embodiments, the one or more edge controllers 104 may operate as intermediary node to transact data between a respective facility 102 and/or the cloud 106. In some example embodiments, each of the one or more edge controllers 104 is capable of processing and/or filtering the collected data so as to be compatible with the cloud 106. In some example embodiments, each of the one or more facilities 102 may comprise a respective gateway to transact data between a respective facility 102 and/or the cloud 106. Accordingly, in some example embodiments, gateway may operate as intermediary node to transact data between a respective facility 102 and/or the cloud 106. In some example embodiments, the cloud 106 includes one or more servers that may be programmed to communicate with the one or more facilities 102 and to exchange data as appropriate. The cloud 106 may be a single computer server or may include a plurality of computer servers. In some example embodiments, the cloud 106 may represent a hierarchal arrangement of two or more computer servers, where perhaps a lower level computer server (or servers) processes telemetry data, for example, while a higher-level computer server oversees operation of the lower level computer server or servers.

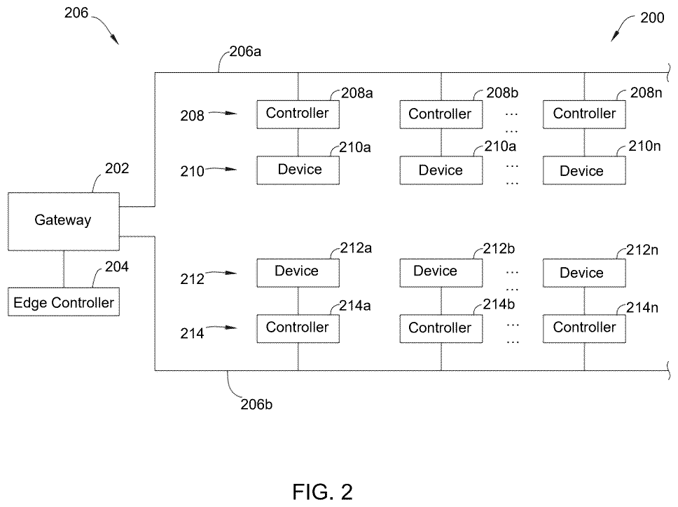

FIG. 2 illustrates a schematic diagram showing an exemplary facility in accordance with one or more example embodiments described herein. In one or more example embodiments, an example facility 200 described herein corresponds to one of the facilities 102 described in accordance with FIG. 1 of the current disclosure. In various example embodiments, the example facility 200 of FIG. 2 comprises one or more assets communicatively coupled via multiple networks 206 (e.g., communication channels). For instance, as illustrated in FIG. 2, the facility 200 includes a first network 206a and a second network 206b. In some example embodiments, the facility 200 may include only a single network 206. In some example embodiments, the facility 200 may include multiple networks 206. Each of the networks 206 may include any available network infrastructure. In some example embodiments, each of the networks 206 may independently be, for example, a BACnet network, a NIAGARA network, a NIAGARA CLOUD network, or others. Accordingly, in some example embodiments, the facility 200 comprises the one or more assets and/or devices in communication with a gateway 202 via corresponding communication channel (e.g., networks 206a and/or 206b). Said differently, each of the network represents a sub-network supported by an underlined network communication/IoT protocol and incorporating a cluster of endpoints (e.g. assets, controllers etc. in building facility).

In some example embodiments, one or more first assets 210a, 210b, . . . 210n (collectively “first assets 210”) are operably coupled to the first network 206 a via one or more first controllers 208a, 208b, . . . 208n (collectively “first controllers 208”). In some example embodiments, the first controllers 208 process data associated with the first assets 210, the one or more processes, and the one or more products in the facility 200. The one or more products may be manufactured by the first assets 210 using the one or more processes in the facility 200. The data associated with the first assets 210, the one or more processes, and the one or more products is received from the Enterprise Resource Planning (ERP) or the Enterprise Data Warehouse (EDW) systems. In this regard, the data may be related to routing data, quality notification data, and/or the like associated with one or more products manufactured in the facility 200. The routing data describes the path and sequence of operations that raw materials undergo as they pass through various manufacturing processes and assets (e.g., machines, workstations). The quality notification data indicates results of quality inspections based on whether the one or more products meet specific quality standards. In some other example embodiments, the first controllers 208 are operably coupled to one or more sensors associated with different types of the first assets 210 within the facility 200. In some example embodiments, at least some of the first assets 210 include, but may not be limited to modular workstations, machinery, tools, mobile equipment, and/or like. In this regard, the one or more sensors may correspond to cameras, temperature sensors, pressure sensors, humidity sensors, and/or the like. Per this aspect, the one or more sensors associated with the first assets 210 may detect temperature conditions, pressure conditions, humidity conditions, and/or like associated with the first assets 210.

In some example embodiments, the first controllers 208 control operation of at least one of the first assets 210 and at least one of the one or more processes in the facility 200. In this regard, the first controllers 208 process and/or analyze the received data to derive one or more insights for at least some of the first assets 210 and the one or more manufacturing processes in the facility 200. In this regard, the insights may be related to the routing data, the quality notification data, and/or the like associated with at least some of the one or more intermediate and/or final products. Also, in some example embodiments, the first controllers 208 may undertake one or more corrective actions to control quality of the intermediate and/or final products by optimizing the first assets 210 and the one or more manufacturing processes based on the derived insights within the facility 200. In accordance with some example embodiments, the first controllers 208 may be built into one or more of the corresponding first assets 210 and need not be a separate component. Whereas, in accordance with some other example embodiments, the first controllers 208 may be virtual controllers that may be implemented within a virtual environment hosted by one or more computing devices (not illustrated). In another example embodiment, at least some of the first assets 210 may be controllers. In such case, the first assets 210 need not have a separate corresponding controller of the first controllers 208.

In some example embodiments, one or more second assets 212a, 212b, . . . 212n (collectively “second assets 212”), are operably coupled to the second network 206 b via one or more second controllers 214a, 214b, . . . 214n (collectively “second controllers 214”). In some example embodiments, the second controllers 214 process data associated with the second assets 212, the one or more processes, and the one or more products in the facility 200. The one or more products may be manufactured by the second assets 212 using the one or more processes in the facility 200. The data associated with the second assets 212, the one or more processes, and the one or more products is received from the Enterprise Resource Planning (ERP) or the Enterprise Data Warehouse (EDW) systems. In this regard, the data may be related to routing data, quality notification data, and/or the like associated with one or more products manufactured in the facility 200. The routing data describes the path and sequence of operations that raw materials undergo as they pass through various manufacturing processes and assets (e.g., machines, workstations). The quality notification data indicates results of quality inspections based on whether the one or more products meet specific quality standards. In some other example embodiments, the second controllers 214 are operably coupled to one or more sensors associated with different types of the second assets 212 within the facility 200. In some example embodiments, at least some of the second assets 212 include, but may not be limited to modular workstations, machinery, tools, mobile equipment, and/or like. In this regard, the one or more sensors may correspond to cameras, temperature sensors, pressure sensors, humidity sensors, and/or the like. Per this aspect, the one or more sensors associated with the second assets 212 may detect temperature conditions, pressure conditions, humidity conditions, and/or like associated with the second assets 212.

In some example embodiments, the second controllers 214 control operation of at least one of the second assets 212 and at least one of the one or more processes in the facility 200. In this regard, the second controllers 214 process and/or analyze the received data to derive one or more insights for at least some of the second assets 212 and the one or more manufacturing processes in the facility 200. In this regard, the insights may be related to the routing data, the quality notification data, and/or the like associated with at least some of the one or more intermediate and/or final products. Also, in some example embodiments, the second controllers 214 may undertake one or more corrective actions to control quality of intermediate and/or final products by optimizing the second assets 212 and one or more manufacturing processes based on the derived insights within the facility 200. In accordance with some example embodiments, the second controllers 214 may be built into one or more of the corresponding second assets 212 and need not be a separate component. Whereas, in accordance with some other example embodiments, the second controllers 214 may be virtual controllers that may be implemented within a virtual environment hosted by one or more computing devices (not illustrated). In another example embodiment, at least some of the second assets 212 may be controllers. In such case, the second assets 212 need not have a separate corresponding controller of the second controllers 214.

Further, in some example embodiments, the facility 200 includes a gateway 202 that is operably coupled with the first network 206a and the second network 206b. In one example embodiment, the gateway 202 may be operably coupled with the first network 206a but not with the second network 206b. In another example embodiment, the gateway 202 may be operably coupled with the second network 206b but not with the first network 206a. Accordingly, in some example embodiments, the gateway 202 is a legacy controller. In some example embodiments, the gateway 202 may be absent. In accordance with some example embodiments, an edge controller 204 is installed within the facility 200. In some example embodiments, the edge controller 204 may be operably coupled with the gateway 202. In this regard, the edge controller 204 serves as an intermediary node between the first controllers 208, the second controllers 214, and the cloud 106 (as described in accordance with FIG. 1 of the current disclosure). For instance, in an example, the edge controller 204 may pull data from the first controllers 208 and the second controllers 214 and provide the data to the cloud 106. In an example embodiment, the edge controller 204 is configured to discover the first assets 210, the second assets 212, the first controllers 208, and/or the second controllers 214 that are connected along a local network such as the network 206. In an example embodiment, the network protocol of the network 206 includes discovery commands that, for example, are used to request that each of the first assets 210 and the second assets 212 connected to the network 206 identify themselves. Whereas, in another example, the edge controller 204 is configured to discover the first assets 210 and the second assets 212 regardless of an underlaying protocol supported by the first assets 210 and the second assets 212. In other words, the edge controller 204 may discover the first assets 210 and the second assets 212 supported by different protocols (e.g., BACnet, Modbus, LonWorks, SNMP, MQTT, Foxs, OPC UA etc.).

Further, in some example embodiments, the edge controller 204 interrogates any assets it finds operably coupled to the network 206 to obtain additional information from those assets that further helps the edge controller 204 and/or the cloud 106 identify the connected assets, functionality of the assets, connectivity of the local controllers and/or the assets, types of operational data that is available from the local controllers and/or the assets, types of alarms that are available from the local controllers and/or the assets, and/or any other suitable information.

More generally, and in some example embodiments, the edge controller 204 is communicatively coupled to one or more assets, via one or more networks. According to various example embodiments described herein, the assets include, for example, but not limited to, machines, modular workstations, tools, equipment, and/or like. These may correspond to, for example, one or more of the first assets 210 and the second assets 212. According to an example embodiment, the edge controller 204 is configured to receive the routing data and the quality notification data corresponding to the one or more products in the facility 200 (e.g., but may not be limited to, an industrial plant, a factory, etc.).

In accordance with an example embodiment, the edge controller 204 is configured to discover and identify the one or more assets which are communicatively coupled to the edge controller 204. Further, upon identification of the assets, the example edge controller 204 is configured to pull the data from the SAP system such as Enterprise Resource Planning (ERP) or the Enterprise Data Warehouse (EDW) systems. In an example, these assets may be located on-premises in the facility 200. The edge controller 204 is configured to pull the data by sending one or more data interrogation requests to the SAP system. These data interrogation requests may be based on a protocol supported by the SAP system.

In accordance with an example embodiment, the edge controller 204 is configured to receive the routing data and the quality notification data in various data formats or different data structures. In an example, a format of the routing data and the quality notification data received at the edge controller 204 may be in accordance with a communication protocol of the network supporting transaction of data amongst two or more network nodes (i.e., the edge controller 204 and the asset). As may be appreciated, in some example embodiments, the various assets in the facility 200 may be supported by one or more of various network protocols (e.g., IOT protocols like BACnet, Modbus, LonWorks, SNMP, MQTT, Foxs, OPC UA etc.). Accordingly, and in some cases, the edge controller 204 is configured to pull the data in accordance with communication protocol supported by the one or more assets.

In some example embodiments, the edge controller 204 is configured to process the received data and transform the data into a unified data format. The unified data format is referred hereinafter as a common object model. In an example, the common object model is in accordance with an object model that may be required by one or more data analytics applications or services, supported at the cloud 106. In some example embodiments, the edge controller 204 may perform data normalization to normalize the received data into a pre-defined data format. In an example, the pre-defined format may represent a common object model in which the edge controller 204 may further push the data to the cloud 106. In some example embodiments, the edge controller 204 is configured to establish a secure communication channel with the cloud 106. In this regard, the data may be transacted between the edge controller 204 and the cloud 106, via the secure communication channel. In some example embodiments, the edge controller 204 may send the data to the cloud 106 automatically at pre-defined time intervals. In some example embodiments, at least a part of the data may correspond to historic data. In some example embodiments, the edge controller 204 and/or the cloud 106 may derive the one or more insights associated in the facility 200 based on the common object model as well.

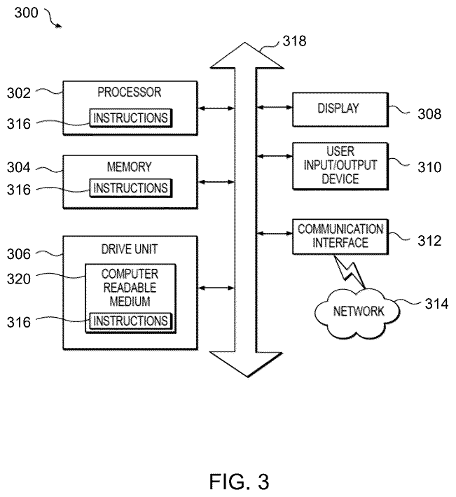

FIG. 3 illustrates a schematic diagram showing an implementation of a controller that may execute techniques in accordance with one or more example embodiments described herein. The controller 300 may include a set of instructions that may be executed to cause the controller 300 to perform any one or more of the methods or computer-based functions disclosed herein. The controller 300 may operate as a standalone device or may be connected, e.g., using a network, to other computer systems or peripheral devices.

In a networked deployment, the controller 300 may operate in the capacity of a server or as a client in a server-client user network environment, or as a peer computer system in a peer-to-peer (or distributed) network environment. The controller 300 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 300 may be implemented using electronic devices that provide voice, video, or data communication. Further, while the controller 300 is illustrated as a single system, the term “system” shall also be taken to include any collection of systems or sub-systems that individually or jointly execute a set, or multiple sets, of instructions to perform one or more computer functions.

As illustrated in FIG. 3, the controller 300 may include a processor 302, e.g., a central processing unit (CPU), a graphics processing unit (GPU), or both. The processor 302 may be a component in a variety of systems. For example, the processor 302 may be part of a standard computer. The processor 302 may be one or more general processors, digital signal processors, application specific integrated circuits, field programmable gate arrays, servers, networks, digital circuits, analog circuits, combinations thereof, or other now known or later developed devices for analyzing and processing data. The processor 302 may implement a software program, such as code generated manually (i.e., programmed).

The controller 300 may include a memory 304 that may communicate via a bus 318. The memory 304 may be a main memory, a static memory, or a dynamic memory. The memory 304 includes, but may not be limited to, computer readable storage media such as various types of volatile and non-volatile storage media, including but may not be limited to, random access memory, read-only memory, programmable read-only memory, electrically programmable read-only memory, electrically erasable read-only memory, flash memory, magnetic tape or disk, optical media and the like. In one implementation, the memory 304 includes a cache or random-access memory for the processor 302. In alternative implementations, the memory 304 is separate from the processor 302, such as a cache memory of the processor 302, the system memory, or other memory. The memory 304 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 304 is operable to store instructions executable by the processor 302. The functions, acts or tasks illustrated in the figures or described herein may be performed by the processor 302 executing the instructions stored in the memory 304. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the controller 300 may further include a display 308, such as a liquid crystal display (LCD), an organic light emitting diode (OLED), a flat panel display, a solid-state display, a cathode ray tube (CRT), a projector, a printer or other now known or later developed display device for outputting determined information. The display 308 may act as an interface for the user to see the functioning of the processor 302, or specifically as an interface with the software stored in the memory 304 or in the drive unit 306.

Additionally or alternatively, the controller 300 may include an input/output device 310 configured to allow a user to interact with any of the components of controller 300. The input/output device 310 may be a number pad, a keyboard, or a cursor control device, such as a mouse, or a joystick, touch screen display, remote control, or any other device operative to interact with the controller 300.

The controller 300 may also or alternatively include drive unit 306 implemented as a disk or optical drive. The drive unit 306 may include a computer-readable medium 320 in which one or more sets of instructions 316, e.g. software, may be embedded. Further, the instructions 316 may embody one or more of the methods or logic as described herein. The instructions 316 may reside completely or partially within the memory 304 and/or within the processor 302 during execution by the controller 300. The memory 304 and the processor 302 also may include computer-readable media as discussed above.

In some systems, a computer-readable medium 320 includes instructions 316 or receives and executes instructions 316 responsive to a propagated signal so that a device connected to a network 314 may communicate voice, video, audio, images, or any other data over the network 314. Further, the instructions 316 may be transmitted or received over the network 314 via a communication port or interface 312, and/or using a bus 318. The communication port or interface 312 may be a part of the processor 302 or may be a separate component. The communication port or interface 312 may be created in software or may be a physical connection in hardware. The communication port or interface 312 may be configured to connect with a network 314, external media, the display 308, or any other components in controller 300, or combinations thereof. The connection with the network 314 may be a physical connection, such as a wired Ethernet connection or may be established wirelessly as discussed below. Likewise, the additional connections with other components of the controller 300 may be physical connections or may be established wirelessly. The network 314 may alternatively be directly connected to a bus 318.

While the computer-readable medium 320 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 320 may be non-transitory, and may be tangible.

The computer-readable medium 320 may include a solid-state memory such as a memory card or other package that houses one or more non-volatile read-only memories. The computer-readable medium 320 may be a random-access memory or other volatile re-writable memory. Additionally or alternatively, the computer-readable medium 320 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, may be constructed to implement one or more of the methods described herein. Applications that may include the apparatus and systems of various implementations may broadly include a variety of electronic and computer systems. One or more implementations described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

The controller 300 may be connected to a network 314. The network 314 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but may not be limited to, TCP/IP based networking protocols. The network 314 may include wide area networks (WAN), such as the Internet, local area networks (LAN), campus area networks, metropolitan area networks, a direct connection such as through a Universal Serial Bus (USB) port, or any other networks that may allow for data communication. The network 314 may be configured to couple one computing device to another computing device to enable communication of data between the devices. The network 314 may generally be enabled to employ any form of machine-readable media for communicating information from one device to another. The network 314 may include communication methods by which information may travel between computing devices. The network 314 may be divided into sub-networks. The sub-networks may allow access to all of the other components connected thereto or the sub-networks may restrict access between the components. The network 314 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations may include distributed processing, component/object distributed processing, and parallel processing. Alternatively, virtual computer system processing may be constructed to implement one or more of the methods or functionalities as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

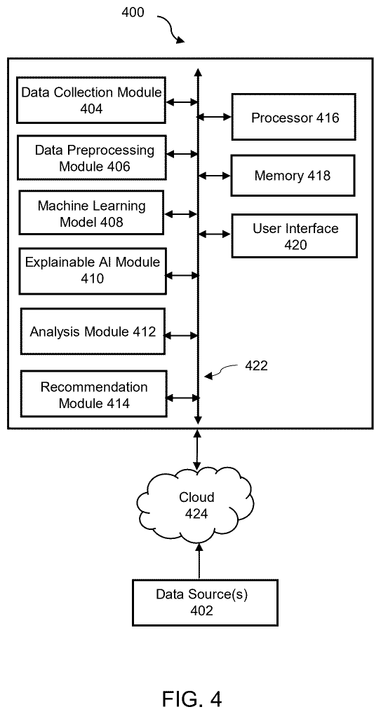

FIG. 4 is an exemplary block diagram illustrating an implementation of the Quality Management System 400 in the facility, in accordance with one or more embodiments of the present disclosure. In accordance with one or more example embodiments, the Quality Management System 400 described herein monitors quality of the one or more products in the facility by optimizing the one or more assets and the one or more manufacturing processes. In accordance with one or more example embodiments, the Quality Management System 400 described herein improves quality of the one or more intermediate and/or final products by identifying one or more problematic assets and/or processes. In accordance with one or more example embodiments, the Quality Management System 400 described herein uses the routing data from the ERP or EDW systems to track the flow of the raw material through the flexible shop floor. In accordance with one or more example embodiments, the Quality Management System 400 described herein utilizes the supervised ML model to map the flow of the raw material to the quality notification data in the ERP or EDW systems. In other words, the supervised ML model learns the relationship between the processes/assets (routing data) and the quality notification data. In accordance with one or more example embodiments, the Quality Management System 400 described herein utilizes the multi-process Explainable AI analysis (e.g. feature importance, SHAP values) to identify the potential assets and/or potential processes which may cause quality issues. In accordance with one or more example embodiments, the Quality Management System 400 described herein specifically analyzes the sub-system/sub-process parameters, e.g., environmental or operational factors (e.g., temperature, pressure, humidity) corresponding to the assets and/or processes that are identified as problematic. This makes the analysis more efficient and effective. In accordance with one or more example embodiments, the Quality Management System 400 described herein includes a cloud-based user interface to visualize key performance indicators (KPIs) of the manufacturing processes and facilitate the generation of one or more corrective actions using the multi-process Explainable AI analysis based on the supervised ML model. Hence, the one or more corrective actions could be timely performed by the operators. In accordance with one or more example embodiments, the Quality Management System 400 described herein identifies one or more causal factors corresponding to the one or more assets and/or one or more processes without instrumenting extra check points in the flexible shop floor. The present disclosure could be utilized in real time as new data is entered into the Quality Management System 400.

In this regard, the Quality Management System 400 receives routing data and quality notification data associated with the one or more products in the facility such as the flexible shop floor. The routing data indicates flow of raw material through the one or more assets and the one or more processes to manufacture the one or more products in the flexible manufacturing environment. The quality notification data indicates whether the plurality of products satisfies the specific quality standard. The Quality Management System 400 utilizes the supervised ML model to correlate the routing data and the quality notification data associated with each of the plurality of products. The Quality Management System 400 identifies, via the supervised ML model, at least one causal asset and/or at least one causal process based on the correlation of the routing data and the quality notification data. The Quality Management System 400 generates one or more recommendations including the one or more corrective actions associated with the at least one causal asset and/or the at least one causal process in the facility. The Quality Management System 400 displays the one or more recommendations on the user interface of the display device.

The present invention offers several valuable insights that can significantly improve quality management and manufacturing efficiency. For example, the Quality Management System 400 tracks process failures by pinpointing specific assets and/or processes responsible for the quality failures. The use of the supervised ML model (such as XGBoost) helps in identifying assets or process parameters which are directly influencing quality outcomes. Whereas in another example, the Quality Management System 400 predicts potential quality issues corresponding to the one or more assets and/or processes before they occur by analyzing historical data using one or more ML algorithms. This proactive approach helps identify problematic areas early in the manufacturing process. Further, the Quality Management System 400 indicates how specific variables such as, but not limited to type of the asset, asset settings, process settings, and/or like affect quality of the one or more products allowing for focused improvements on the most influential factors. Accordingly, the Quality Management System 400 facilitates a practical application of monitoring assets and manufacturing processes consistently and identifying and addressing the quality issues promptly. Further, the use of the one or more ML algorithms prevents recurring issues, leading to more efficient production and reducing defects in the finished products. Therefore, the Quality Management System 400 identifies root causes of quality issues, predicting potential defects, providing actionable recommendations, enabling real-time monitoring, and supporting continuous process optimization and improvement.

In an example embodiment the Quality Management System 400 is a server system (e.g., a server device) that facilitates a data analytics platform between one or more computing devices, one or more data sources, and/or one or more assets. In one or more example embodiments, the Quality Management System 400 is a device with one or more processors and a memory. Also, in some example embodiments, the Quality Management System 400 is implementable via the cloud 106. The Quality Management System 400 is implementable in one or more facilities related to one or more technologies, for example, but not limited to, enterprise technologies, connected building technologies, industrial technologies, Internet of Things (IoT) technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, industrial technologies, cybersecurity technologies, navigation technologies, asset visualization technologies, oil and gas technologies, petrochemical technologies, refinery technologies, process plant technologies, procurement technologies, and/or one or more other technologies.

In some example embodiments, the Quality Management System 400 comprises one or more components and/or sub-systems such as data source(s) 402, a data collection module 404, a data preprocessing module 406, a machine learning (ML) model 408, an Explainable AI module 410, an analysis module 412, a recommendation module 414, and/or a user interface 420. Additionally, in one or more example embodiments, the Quality Management System 400 comprises a processor 416 and/or memory 418. In one or more example embodiments, one or more components and/or sub-systems of the Quality Management System 400 may be communicatively coupled to the processor 416 and/or the memory 418 via a bus 422. In certain example embodiments, one or more aspects of the Quality Management System 400 (and/or other systems, apparatuses and/or processes disclosed herein) constitute executable instructions embodied within a computer-readable storage medium (e.g., the memory 418). For instance, in an example embodiment, the memory 418 stores computer executable component and/or executable instructions (e.g., program instructions). Furthermore, the processor 416 facilitates execution of the computer executable components and/or the executable instructions (e.g., the program instructions). In an example embodiment, the processor 416 is configured to execute instructions stored in memory 418 or otherwise accessible to the processor 416.

The processor 416 is a hardware entity (e.g., physically embodied in circuitry) capable of performing operations according to one or more embodiments of the disclosure. Alternatively, in an example embodiment where the processor 416 is embodied as an executor of software instructions, the software instructions configure the processor 416 to perform one or more algorithms and/or operations described herein in response to the software instructions being executed. In an example embodiment, the processor 416 is a single core processor, a multi-core processor, multiple processors internal to the Quality Management System 400, a remote processor (e.g., a processor implemented on a server), and/or a virtual machine. In certain example embodiments, the processor 416 is in communication with the memory 418, the data source(s) 402, the data collection module 404, the data preprocessing module 406, the machine learning (ML) model 408, the Explainable AI module 410, the analysis module 412, the recommendation module 414, and/or the user interface 420 via the bus 422 to, for example, facilitate transmission of data between the processor 416, the memory 418, the data source(s) 402, the data collection module 404, the data preprocessing module 406, the machine learning (ML) model 408, the Explainable AI module 410, the analysis module 412, the recommendation module 414, and/or the user interface 420. In some example embodiments, the processor 416 may be embodied in a number of different ways and, in certain example embodiments, includes one or more processing devices configured to perform independently. Additionally or alternatively, in one or more example embodiments, the processor 416 includes one or more processors configured in tandem via bus 422 to enable independent execution of instructions, pipelining of data, and/or multi-thread execution of instructions.

The memory 418 is non-transitory and includes, for example, one or more volatile memories and/or one or more non-volatile memories. In other words, in one or more example embodiments, the memory 418 is an electronic storage device (e.g., a computer-readable storage medium). The memory 418 is configured to store information, data, content, one or more applications, one or more instructions, or the like, to enable the Quality Management System 400 to carry out various functions in accordance with one or more embodiments disclosed herein. In accordance with some example embodiments described herein, the memory 418 may correspond to an internal or external memory of the Quality Management System 400. In some examples, the memory 418 may correspond to a database communicatively coupled to the Quality Management System 400. As used herein in this disclosure, the term “component,” “system,” and the like, is a computer-related entity. For instance, “a component,” “a system,” and the like disclosed herein is either hardware, software, or a combination of hardware and software. As an example, a component is, but is not limited to, a process executed on a processor, a processor circuitry, an executable component, a thread of instructions, a program, and/or a computer entity.

In one or more embodiments, the data source(s) 402 may represent different types of sources within the facility. In one or more example embodiments, the data source(s) 402 may include, but not limited to, Enterprise Resource Planning (ERP) system, Enterprise Data Warehouse (EDW) system, Quality Management tools, Quality Inspection tools, Manufacturing Execution Systems (MES), IoT sensors, Industrial Control Systems (ICS), and/or like. The data source(s) 402 are responsible for generation of the routing data, operational data, manufacturing or production data, quality notification data, sensor data, and/or like.

The routing data serves as a comprehensive map of the production process, outlining the path and sequence of operations that raw materials undergo as they pass through various assets (machines or workstations) and manufacturing processes. Routing data is related to the process parameters, asset data, and similar data associated with the production process. The process parameters might include temperature, pressure, humidity, or other conditions relevant to manufacturing processes that influence product quality. The asset data refers to the data about the machinery, workstations, or other equipment used in production process. The asset data may include information on asset type, settings, status, and performance metrics. Each routing path represents a unique trajectory that the raw materials take, enhancing clarity of the production flow and aiding in quality control. This allows for a comprehensive view of how raw materials progress through various manufacturing stages. The routing data outlines the specific steps, resources, and machinery required to transform raw materials into finished products.

The quality notification data indicates quality measurements and inspection results. The quality notification data includes a quality notification that describes non-conformance with the specific quality standard. The quality notification contains functions for capturing and processing problems or defects that are identified during inspection. The quality notification is used to analyze recorded defects and perform root cause analysis of problems. The quality notification may be categorized into two primary outcomes: “pass” or “fail”. When a quality notification results in a “pass,” it indicates that the inspected product, process, or batch meets the established quality standards and specifications. A “fail” notification indicates that the product or process did not meet the required quality standards. This could involve defects, deviations, or non-conformances that could affect product performance or safety. Additionally, the quality notification data often contains requests for appropriate corrective actions, ensuring that any identified issues are promptly addressed to maintain quality standards and improve overall manufacturing or production processes.

In one or more embodiments, the data collection module 404 may continuously collect and aggregate the routing data and the quality notification data associated with the one or more intermediate and/or final products from various data source(s) 402. The data collection module 404 is crucial in tracking the routing data and the quality notification data. In an instance, the routing data may include, but not limited to, process parameters, asset data, and/or like. The quality notification data may include, but not limited to, inspection results, one or more defects or deviations, and/or like. The data collection module 404 includes mechanisms for obtaining the real-time data associated with the one or more intermediate and/or final products from the data source(s) 402.

In one or more embodiments, the data preprocessing module 406 plays a crucial role in aggregating and storing the real-time data and handles integration of the real-time data from various data source(s) 402 in the Quality Management System 400. The data preprocessing module 406 uses data pipelines and streaming technologies for real-time data processing. This ensures compatibility with various data source(s) 402 and smooth integration into the Quality Management System 400. This also involves configuring data transfer protocols and ensuring compatibility between the data collection module 404 and the data preprocessing module 406. The data preprocessing module 406 includes a time-series database that can efficiently handle large volumes of data, especially when data is collected in real time over a period. This is particularly useful for manufacturing environments where process data is generated continuously and needs to be stored in a structured way to analyze trends over time. In one or more embodiments, the data preprocessing module 406 performs data cleaning to remove or correct erroneous or incomplete data and subsequently performs data normalization on the incoming data to ensure consistency and reliability of the data for further analysis. Normalization standardizes the data, especially when multiple sources are involved with potentially different units or scales of measurement. For example, it may convert all temperature readings to the same unit (e.g., Celsius) or normalize data to a standard scale. Therefore, the data preprocessing module 406 ensures that real-time data is properly aggregated, cleaned, and normalized for subsequent analysis such as machine learning modeling or decision-making within the Quality Management System 400.

In one or more embodiments, the Machine Learning (ML) Model 408 may include one or more supervised ML models (hereinafter, “the supervised ML model”). The supervised ML model plays a crucial role in identifying problematic assets or processes in the flexible manufacturing environment. The supervised ML model is used to establish a relationship between the routing data and the quality notification data. By correlating the routing data and the quality notification data, the supervised ML model creates a forward map between the routing data and the quality notification data, helping to trace back to the specific processes or assets responsible for any defects. This mapping helps identify the root causes of quality issues, making it easier to pinpoint where corrective actions are needed. This identification of the exact point of failure allows for targeted corrective actions, such as adjusting asset settings or refining operational processes. In an example, the supervised ML model such as XGBoost (gradient-boosting decision tree) processes input variables. The input variables could be continuous variables and discrete variables. XGBoost is a powerful algorithm that can handle tabular data with both continuous and discrete variables. XGBoost may manage large, complex datasets and capture non-linear relationships between input data and the target outcome. Continuous variables may take any value within a range and are often measured rather than counted. For instance, continuous variables may include material thickness, recycling percentage (proportion of raw materials that are recycled in the manufacturing process), and/or like. Discrete variables consist of distinct values that can be counted. For instance, the assets in the manufacturing process are discrete variables. Each asset represents a specific machine or workstation involved in the production. Once a dataset that includes both discrete and continuous variables is compiled, a comprehensive table is created that serves as input for the supervised ML model. This table would typically include discrete and continuous variables. The target variable could be the binary inspection result (“1” and “0”, where “1” is represented as “pass” and “0 ” is represented as “fail”). The supervised ML model is trained based on the historical data and the real-time data. Once trained, the supervised ML model may predict the specific assets or processes that are most likely contributing to quality issues, thus enabling targeted corrective actions.

In one or more embodiments, the Explainable AI module 410 utilizes the multi-process Explainable AI analysis by considering feature importance or the SHAP values to interpret the output of the supervised ML model. The SHAP values provide a clear framework to understand the contribution of each feature (input variables) to the model's predictions. SHAP values provide clarity on how each input feature (e.g., asset type, process parameters, material properties) influences the prediction of quality outcomes. This helps identify critical factors that contribute to quality failures. Each SHAP value quantifies the impact of a specific feature on the prediction. A positive SHAP value indicates that the feature increases the likelihood of the prediction, while a negative SHAP value indicates that the feature reduces the likelihood of the prediction. This model also learns from historical data, enabling it to predict potential quality issues based on the routing paths. The Explainable AI module 410 may effectively identify which assets in the routing are most influential with respect to quality notifications and additionally determines the potential reasons for the specific quality notification, enabling more informed decision-making and improved quality control. This insight allows for targeted interventions, such as optimizing specific assets or adjusting material properties to enhance product quality. For model creation with XGBoost, the dataset is split into training dataset and testing dataset, typically using 80% for training the model and 20% for testing the model's performance. During the training phase, the supervised ML model learns to map the features (input variables) to the binary inspection results (target variables). During the testing phase, the model's performance is evaluated based on the testing dataset. A high accuracy indicates that the model effectively predicts the inspection outcomes. The Accuracy of the model is determined using the formula:
Accuracy=Number of Accurate Predictions/Total Number of Predictions
If the accuracy meets the predetermined threshold, further analysis is performed. If not, the features may be re-evaluated by collecting more data.

In one or more embodiments, the analysis module 412 uses perturbation importance to assess the sensitivity of the model based on changes in feature values. For each feature, values in the testing dataset are temporarily shuffled and the decrease in the accuracy of the model is evaluated. The greater the drop in accuracy when the specific feature is shuffled, the more important that feature is to the model. This approach provides insights into which variables have the most significant influence on the model's predictions, helping prioritize focus areas for quality improvement. Further, to evaluate the importance of each feature in the dataset using perturbation importance, the supervised ML model is trained on the original dataset and then the predictions are obtained for the testing dataset and the model's accuracy is being calculated. Further, for each feature in the dataset, the values of that feature are shuffled or randomized in the testing dataset. This disrupts the relationship between that feature and the target variable while keeping other features intact. The model predictions are re-evaluated on the perturbed test dataset and the new accuracy is calculated based on these predictions. The difference in accuracy is being calculated between the original model predictions and the perturbed predictions. A larger difference indicates that the feature is sensitive and has a strong influence on the model's performance. Conversely, if the difference is small, the feature may have a minimal impact on the predictions. For features related to specific assets, it may be identified which assets are associated with the most sensitive features. This helps in pinpointing which assets may be critical in influencing quality outcomes. Therefore, by comparing the accuracy of the original model with that of the perturbed dataset, the sensitivity of each feature may be determined. Features that cause significant changes in accuracy when perturbed are deemed important for the model's predictions. This method provides valuable insights into the relationships between assets and quality outcomes, allowing for targeted improvements in manufacturing processes. If the perturbed feature corresponds to an asset or a specific process parameter, it may indicate that problems related to that asset or parameter are critical to understanding quality issues. For example, if material thickness shows a large sensitivity, it may warrant closer monitoring or adjustments in manufacturing processes related to material handling. Also, by identifying which features are most influential, quality improvement efforts may be prioritized on those areas that have the potential to yield the most significant impact on overall product quality.

In one or more embodiments, the recommendation module 414 generates one or more recommendations including the one or more corrective actions associated with the causal assets and/or causal processes in the facility. The recommendation module 414 suggests the one or more corrective actions to resolve the identified issues. The one or more corrective actions may include adjusting asset settings, modifying process parameters such as process flow changes, environmental factors, timing adjustments, and/or like, modifying operational settings, addressing material properties such as material quality, type of material, and/or like. For instance, the recommendation module 414 might suggest reducing the machine speed if a machine's speed is too high and leads to defects in the finished product. In another instance, the recommendation module 414 might recommend fine-tuning the operational parameters, such as adjusting the force or pressure applied during manufacturing if the operational parameters are found to be contributing to defects. In yet another instance, the recommendation module 414 may suggest modifying the environmental factors such as temperature, humidity, and pressure during specific stages of production if a certain range of temperature or humidity is linked to defects. In yet another instance, the recommendation module 414 might suggest using different material batches or changing material suppliers if specific material properties are causing production issues. In yet another instance, the recommendation module 414 may suggest regular maintenance schedules or specific actions like lubrication or replacement of worn-out components if the failure of the asset is due to wear-and-tear or improper maintenance. Further, early identification of issues ensures that corrective actions can be taken proactively, which ultimately reduces the likelihood of quality failures. In addition, by optimizing asset settings, modifying process parameters, and addressing material properties, manufacturers may improve the efficiency of the production line. This leads to reduced downtime, fewer defects, less waste, and ultimately lower production costs. In an embodiment, the recommendation module 414 ensures that the most relevant corrective actions are suggested. This reduces unnecessary interventions and focuses on the areas that will improve quality. By addressing quality issues early, the recommendation module 414 may help in reducing the amount of scrap or rework required. This is critical in manufacturing environments where maintaining tight production schedules and minimizing waste are essential for profitability.

Further, in some example embodiments, the one or more recommendations and/or insights may be transmitted to the user interface 420. In one or more embodiments, the user interface 420 is configured to display the one or more recommendations and/or the one or more insights. In another example, the one or more root causes of the quality issues may be rendered on the user interface 420. The one or more recommendations may be presented in the form reports, dashboard, descriptions, charts, trends, graphs, and/or like. This may include bar charts, pie charts, or line graphs. In one or more example embodiments, the one or more insights include, but may not be limited to, key performance indicators (KPIs), the status of the one or more corrective actions, material adjustments, and/or like. In another embodiment, one or more notifications may be transmitted to the user interface 420. The one or more notification include, but may not be limited to, the quality notification at the inspection level. The user interface 420 may correspond to an interface of a device associated with personnel in the facility. In one example, the user interface 420 may correspond to an interface of a device associated with an operator or the personnel in the facility. In another example, the user interface 420 may correspond to an interface of a device associated with a supervisor of the operator in the facility. In some example embodiments, one or more alert signals may be generated based on the one or more insights. In some example embodiments, the one or more alert signals may be transmitted to the user interface 420. In this regard, in some example embodiments, one or more notifications may be generated on the user interface 420 based on the one or more alert signals. Accordingly, in some examples, the one or more notifications may be visual notifications. Whereas, in some examples, the one or more notifications may be audio notifications. Also, in some example embodiments, the user interface 420 may allow the personnel to provide input and/or feedback regarding the one or more insights. For example, an input may correspond an operator selecting a corrective action. In this regard, the one or more insights may be rendered as visualizations, such as on the user interface 420, to help the personnel such as field operators to identify the one or more insights and thereby undertake appropriate actions.

Further, in some example embodiments, the Quality Management System 400 may utilize the supervised ML model to provide the one or more insights based on the KPIs. Also, in some example embodiments, the supervised ML model may be trained with one or more datasets to facilitate provision of the one or more insights. In this regard, the one or more datasets may be related to the historical data. Additionally, in some example embodiments, the one or more insights may be provided as feedback. In this regard, the supervised ML model may learn over time to provide improved and accurate insights. For example, the Quality Management System 400 may flag one or more actions taken by the personnel in the facility if they are determined to have caused quality concerns. Also, in some example embodiments, the supervised ML model may be trained with one or more new datasets on a regular basis or for a pre-defined time interval to improve relevancy of insights. The Quality Management System 400 implements mechanisms for continuous improvement based on user feedback and the KPIs such as analyzing the historical data and user feedback to optimize the supervised ML model.

Therefore, instead of merely predicting whether a product will pass or fail, the Quality Management System 400 seeks to trace back to the exact processes or assets responsible for quality failures. The Quality Management System 400 can identify the key processes and causal factors without instrumenting extra check points in a shopfloor value stream. This enables a deeper understanding of the underlying causes of defects. By identifying problematic processes and assets, proactive measures could be taken to address issues before they result in failed inspections. This helps in mitigating risks and improving overall quality. Incorporation of routing information allows for a detailed analysis of how different pathways and assets interact in the manufacturing process. This provides context to the quality issues, making it easier to pinpoint where interventions are needed. Understanding the specific assets or processes associated with quality problems allows for targeted corrective actions, such as optimizing asset settings, refining processes, or addressing material handling issues. This inverse analysis enables deeper insights into quality issues, facilitating proactive measures that lead to enhanced quality management and continuous improvement in manufacturing processes.

In some example embodiments, the one or more components, one or more sub-systems, processor 416 and/or memory 418 of the Quality Management System 400 may be communicatively coupled to cloud 424 over a network. In this regard, the one or more components, processor 416 and/or memory 418 along with the cloud 424 manages the quality of one or more intermediate and/or final products in the facility. In some example embodiments, the network may be for example, a Wi-Fi network, a Near Field Communications (NFC) network, a Worldwide Interoperability for Microwave Access (WiMAX) network, a personal area network (PAN), a short-range wireless network (e.g., a Bluetooth® network), an infrared wireless (e.g., IrDA) network, an ultra-wideband (UWB) network, an induction wireless transmission network, a BACnet network, a NIAGARA network, a NIAGARA CLOUD network, and/or another type of network. In some example embodiments, the routing data and the quality notification data received from the data source(s) 402 may be transmitted to the cloud 424. In some example embodiments, the cloud 424 may be configured to perform one or more operations/functionalities of the one or more components, one or more sub-systems, processor 416 and/or memory 418 of the Quality Management System 400.

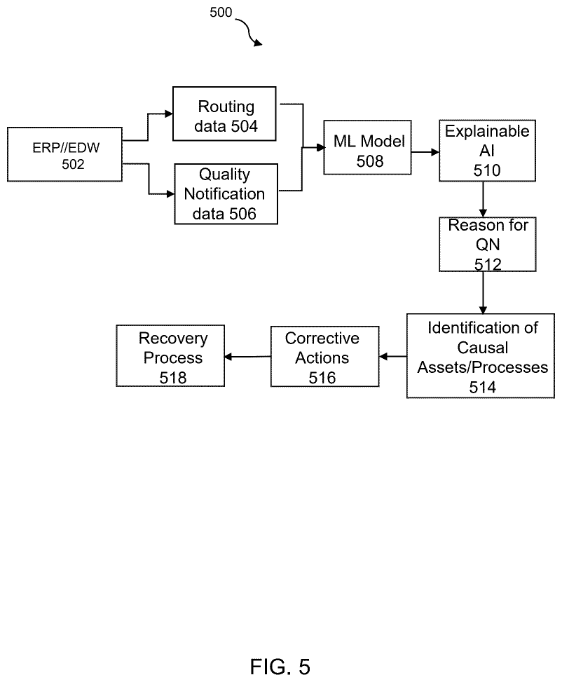

FIG. 5 is an exemplary block diagram illustrating inverse learning of causal assets and/or processes, in accordance with one or more embodiments of the present disclosure. The data source(s) such as ERP and/or EDW system 502 are responsible for generation of the routing data 504 and the quality notification data 506. The routing data 504 serves as a comprehensive map of the production process, outlining the path and sequence of operations that raw materials undergo as they pass through various assets (machines or workstations) and manufacturing processes. Routing data 504 is related to the process parameters, asset data, and similar data associated with the production process. The routing data outlines the specific steps, resources, and machinery required to transform raw materials into finished products. The quality notification data 506 indicates quality measurements and inspection results. The quality notification data 506 includes a quality notification that describes non-conformance with the specific quality standard. The quality notification may be categorized into two primary outcomes: “pass” or “fail”. When a quality notification results in a “pass,” it indicates that the inspected product, process, or batch meets the established quality standards and specifications. A “fail” notification indicates that the product or process did not meet the required quality standards. This could involve defects, deviations, or non-conformances that could affect product performance or safety. For instance, when the number of defects exceeds the acceptable specification, this could mean that there are more flaws than allowed in the final product, which may impact its functionality, durability, or overall quality. In another instance, the product or process fails to conform to the required specifications or customer requirements. This could include discrepancies between what was expected (based on color, design, standards, or customer expectations) and the actual output. Additionally, the quality notification data 506 often contains requests for appropriate corrective actions, ensuring that any identified issues are promptly addressed to maintain quality standards and improve overall manufacturing or production processes.

In one or more embodiments, the ML Model 508 may include one or more supervised ML models (hereinafter, “the supervised ML model”). The supervised ML model plays a crucial role in identifying problematic assets or processes in the flexible manufacturing environment. The supervised ML model is used to establish a relationship between the routing data 504 and the quality notification data 508. By correlating the routing data 504 and the quality notification data 508, the supervised ML model creates a forward map between the routing data 504 and the quality notification data 508, helping to trace back to the specific processes or assets responsible for any defects. This mapping helps identify the root causes of quality issues, making it easier to pinpoint where corrective actions are needed. This identification of the exact point of failure allows for targeted corrective actions, such as adjusting asset settings or refining operational processes. In an example, the supervised ML model such as XGBoost (gradient-boosting decision tree) processes input variables. The input variables could be continuous variables and discrete variables. XGBoost is a powerful algorithm that can handle tabular data with both continuous and discrete variables. XGBoost may manage large, complex datasets and capture non-linear relationships between input data and the target outcome. Continuous variables may take any value within a range and are often measured rather than counted. For instance, continuous variables may include material thickness, recycling percentage (proportion of raw materials that are recycled in the manufacturing process), and/or like. Discrete variables consist of distinct values that can be counted. For instance, the assets in the manufacturing process are discrete variables. Each asset represents a specific machine or workstation involved in the production. Once a dataset that includes both discrete and continuous variables is compiled, a comprehensive table is created that serves as input for the supervised ML model. This table would typically include discrete and continuous variables. The target variable could be the binary inspection result (“1” and “0”, where “1” is represented as “pass” and “0 ” is represented as “fail”). The supervised ML model is trained based on the historical data and the real-time data. Once trained, the supervised ML model may predict the specific assets or processes that are most likely contributing to quality issues, thus enabling targeted corrective actions.

In one or more embodiments, the Explainable AI 510 utilizes the multi-process Explainable AI analysis by considering feature importance or the SHAP values to interpret the output of the supervised ML model. The SHAP values provide a clear framework to understand the contribution of each feature (input variables) to the model's predictions. SHAP values provide clarity on how each input feature (e.g., asset type, process parameters, material properties) influences the prediction of quality outcomes. This helps identify critical factors that contribute to quality failures. Each SHAP value quantifies the impact of a specific feature on the prediction. A positive SHAP value indicates that the feature increases the likelihood of the prediction, while a negative SHAP value indicates that the feature reduces the likelihood of the prediction. This model also learns from historical data, enabling it to predict potential quality issues based on the routing paths. The Explainable AI 510 may effectively identify which assets in the routing are most influential with respect to quality notifications and additionally determines the potential reasons for the specific quality notification, enabling more informed decision-making and improved quality control. This insight allows for targeted interventions, such as optimizing specific assets or adjusting material properties to enhance product quality. For model creation with XGBoost, the dataset is split into training dataset and testing dataset, typically using 80% for training the model and 20% for testing the model's performance. During the training phase, the supervised ML model learns to map the features (input variables) to the binary inspection results (target variables). During the testing phase, the model's performance is evaluated based on the testing dataset. A high accuracy indicates that the model effectively predicts the inspection outcomes. The Accuracy of the model is determined using the formula:

Accuracy=Number of Accurate Predictions/Total Number of Predictions

If the accuracy meets the predetermined threshold, further analysis is performed. If not, the features may be re-evaluated by collecting more data.

In one or more embodiments, the perturbation importance is used to assess the sensitivity of the model based on changes in feature values. For each feature, values in the testing dataset are temporarily shuffled and the decrease in the accuracy of the model is evaluated. The greater the drop in accuracy when the specific feature is shuffled, the more important that feature is to the model. This approach provides insights into which variables have the most significant influence on the model's predictions, helping prioritize focus areas for quality improvement. Further, to evaluate the importance of each feature in the dataset using perturbation importance, the supervised ML model is trained on the original dataset and then the predictions are obtained for the testing dataset and the model's accuracy is being calculated. Further, for each feature in the dataset, the values of that feature are shuffled or randomized in the testing dataset. This disrupts the relationship between that feature and the target variable while keeping other features intact. The model predictions are re-evaluated on the perturbed test dataset and the new accuracy is calculated based on these predictions. The difference in accuracy is being calculated between the original model predictions and the perturbed predictions. A larger difference indicates that the feature is sensitive and has a strong influence on the model's performance. Conversely, if the difference is small, the feature may have a minimal impact on the predictions. For features related to specific assets, it may be identified which assets are associated with the most sensitive features. This helps in pinpointing which assets may be critical in influencing quality outcomes. Therefore, by comparing the accuracy of the original model with that of the perturbed dataset, the sensitivity of each feature may be determined. Features that cause significant changes in accuracy when perturbed are deemed important for the model's predictions. This method provides valuable insights into the relationships between assets and quality outcomes, allowing for targeted improvements in manufacturing processes. If the perturbed feature corresponds to an asset or a specific process parameter, it may indicate that problems related to that asset or parameter are critical to understanding quality issues. For example, if material thickness shows a large sensitivity, it may warrant closer monitoring or adjustments in manufacturing processes related to material handling. Also, by identifying which features are most influential, quality improvement efforts may be prioritized on those areas that have the potential to yield the most significant impact on overall product quality.

The Quality Management System 400 may identify specific reasons 512 behind quality failures, which could be linked to asset malfunctions (e.g., incorrect asset settings, worn-out parts), process anomalies (e.g., temperature fluctuations, incorrect timing), material issues (e.g., variations in material properties). This enables root cause analysis and allows manufacturers to understand the specific reason behind each quality notification, guiding them towards more effective corrective actions.

Based on the identification of the specific reasons 512 behind quality failures, the Quality Management System 400 may flag certain assets (such as specific machines or workstations) or processes (such as particular manufacturing steps or conditions) 514 that are most likely contributing to quality issues.

In one or more embodiments, the Quality Management System 400 generates one or more corrective actions 516 associated with the causal assets and/or causal processes in the facility. The one or more corrective actions 516 may include adjusting asset settings, modifying process parameters such as process flow changes, environmental factors, timing adjustments, and/or like, modifying operational settings, addressing material properties such as material quality, type of material, and/or like.

In the recovery process 518, the Quality Management System may perform one or more actions. For instance, the Quality Management System 400 might suggest reducing the machine speed if a machine's speed is too high and leads to defects in the finished product. In another instance, the Quality Management System 400 might recommend fine-tuning the operational parameters, such as adjusting the force or pressure applied during manufacturing if the operational parameters are found to be contributing to defects. In yet another instance, the Quality Management System 400 may suggest modifying the environmental factors such as temperature, humidity, and pressure during specific stages of production if a certain range of temperature or humidity is linked to defects. In yet another instance, the Quality Management System 400 might suggest using different material batches or changing material suppliers if specific material properties are causing production issues. In yet another instance, the Quality Management System 400 may suggest regular maintenance schedules or specific actions like lubrication or replacement of worn-out components if the failure of the asset is due to wear-and-tear or improper maintenance. This inverse analysis enables deeper insights into quality issues, facilitating proactive measures that lead to enhanced quality management and continuous improvement in manufacturing processes.

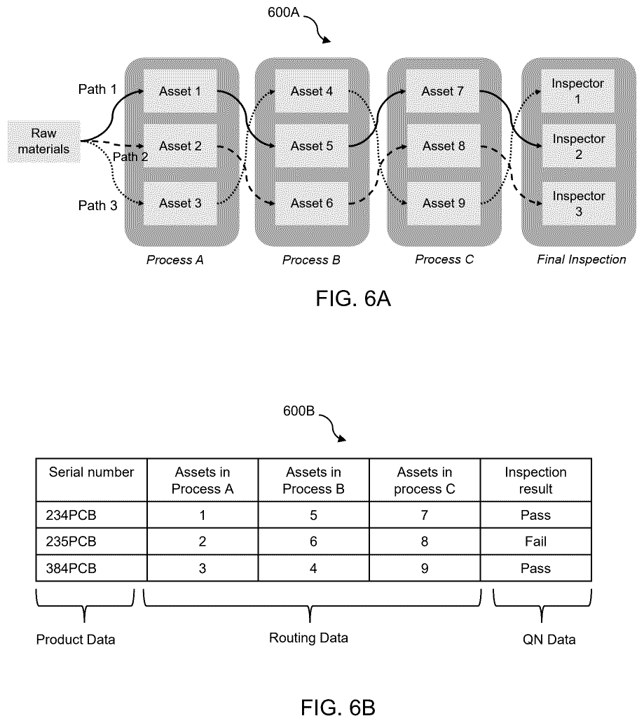

FIG. 6A is an exemplary block diagram illustrating the flexible shop floor, in accordance with one or more embodiments of the present disclosure. As shown in FIG. 6A, in the exemplary flexible shop floor 600A, there are different manufacturing processes - Process A, Process B, Process C. These processes represent different stages or steps in manufacturing of finished products. Each process may involve different types of operations such as assembly, machining, packaging, and/or like. There are different assets—Asset 1, Asset 2 . . . Asset 9. These assets may be the machines, workstations, or tools used in the manufacturing processes. Each asset is assigned to a specific process. There are different Routing paths Path 1, Path 2, and Path 3. Each path represents a unique flow of material through different assets and processes, ultimately leading to inspection points. Path 1 indicates that the raw material is initially processed by Asset 1 via Process A, then processed by Asset 5 via Process B, and finally processed by Asset 7 via Process C before reaching to Inspector 2 for quality inspection. Similarly, Path 2 indicates that the raw material is initially processed by Asset 2 via Process A, then processed by Asset 6 via Process B, and finally processed by Asset 8 via Process C before reaching to Inspector 3 for quality inspection. Similarly, Path 3 indicates that the raw material is initially processed by Asset 3 via Process A, then processed by Asset 4 via Process B, and finally processed by Asset 9 via Process C before reaching to Inspector 1 for quality inspection.

FIG. 6B illustrates an exemplary dataset used for training the supervised ML model, in accordance with one or more embodiments of the present disclosure. The exemplary dataset is generated with respect to FIG. 6A. The exemplary dataset includes the product data, the routing data, and the quality notification data. The product data includes serial numbers of the products manufactured in the flexible shop floor environment as shown in FIG. 6A. Each product is identified uniquely by its serial number, allowing for tracking throughout the manufacturing process and linking the products to subsequent quality inspections. The routing data includes the asset data, process data, and the path data. The asset data tracks the assets (machines or workstations) used in each step of the manufacturing process. For example, for Path 1 (as described in FIG. 6A), the asset data would include Asset 1, Asset 5, and Asset 7, representing the machines used at each process stage. The process data includes information about the specific processes (A, B, C) performed by each asset, detailing what kind of operation is performed at each step. For instance, Process A might involve a machining step, Process B could involve assembly, and Process C might involve packaging. The path data indicates the routing paths (Path 1, Path 2, Path 3) followed by each product. The path data provides a clear mapping of how a product moves through the assets and processes, which is critical for determining where defects or issues may arise. The quality notification data includes the inspection results of the products indicating whether a product passed or failed the quality inspection at the end of its production cycle. For example, the data will include whether products inspected by Inspector 1, Inspector 2, or Inspector 3 were deemed acceptable or defective. This dataset is fed to the supervised ML model to train the model in determining one or more causal assets and/or processes. For instance, the Quality Management System 400 might find that a particular asset, such as Asset 5, or a certain process, such as Process B, has a higher correlation with failure in certain products, allowing for targeted corrective actions.

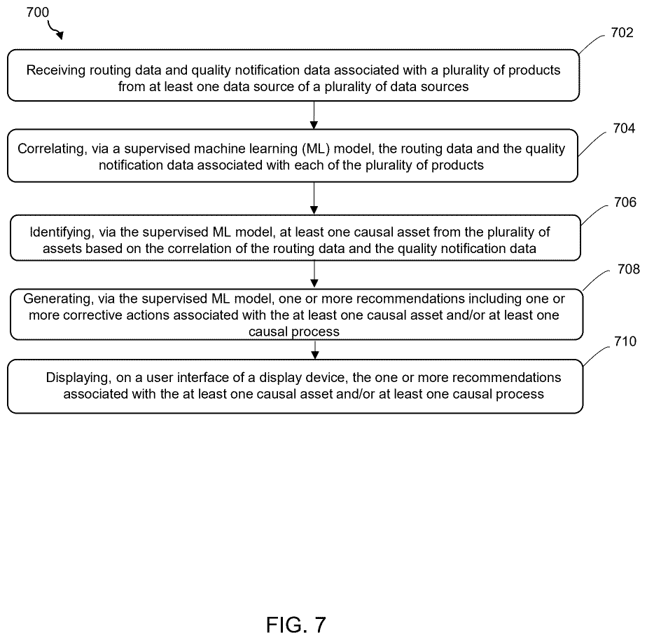

FIG. 7 is a flowchart illustrating a method described in accordance with one or more embodiments of the present disclosure. An exemplary flowchart 700 describes an exemplary method for identifying the one or more causal assets and/or processes and managing the quality of one or more intermediate and/or final products in the facility via the Quality Management System 400. At step 702, the Quality Management System 400 includes means, such as the data collection module 404 to receiving routing data and quality notification data associated with a plurality of products from at least one data source of a plurality of data sources 402. At step 704, the Quality Management System 400 includes means, such as the ML model 408 to correlate the routing data and the quality notification data associated with each of the plurality of products. Further, at step 706, the Quality Management System 400 includes means, such as the ML model 408, Explainable AI module 410, and the Analysis module 412, to identify at least one causal asset from the plurality of assets based on the correlation of the routing data and the quality notification data. Further, at step 708, the Quality Management System 400 includes means, such as the ML model 408 to generate one or more recommendations including one or more corrective actions associated with the at least one causal asset and/or at least one causal process. Further, at step 710, the Quality Management System 400 includes means, such as a user interface 420 of a display device to display the one or more recommendations associated with the at least one causal asset and/or at least one causal process.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the supply management system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

1. A system, comprising:
at least one processor; and
a memory communicatively coupled to the at least one processor, wherein the memory comprises one or more instructions which when executed by the at least one processor, cause the at least one processor to:
receive routing data and quality notification data associated with a plurality of products, wherein the routing data indicates flow of raw material through a plurality of assets and a plurality of processes to manufacture the plurality of products in a flexible manufacturing environment, wherein the quality notification data indicates whether the plurality of products satisfies a predetermined quality standard;
correlate, via a supervised machine learning (ML) model, the routing data and the quality notification data associated with each of the plurality of products;
identify, via the supervised ML model, at least one causal asset from the plurality of assets based on the correlation of the routing data and the quality notification data;
generate, via the supervised ML model, a first recommendation including one or more corrective actions associated with the at least one causal asset from the plurality of assets; and
display, on a user interface of a display device, the first recommendation including the one or more corrective actions associated with the at least one causal asset.

2. The system of claim 1, wherein the at least one processor is further configured to:
identify, via the supervised ML model, at least one causal process from the plurality of processes based on the correlation of the routing data and the quality notification data;
generate, via the supervised ML model, a second recommendation including one or more corrective actions associated with the at least one causal process from the plurality of processes; and
display, on the user interface, the second recommendation including the one or more corrective actions associated with the at least one causal process.

3. The system of claim 1, wherein the routing data is received from one of an Enterprise Resource Planning (ERP) system or an Enterprise Data Warehouse (EDW) system.

4. The system of claim 1, wherein the at least one processor is further configured to train the supervised ML model based on a relationship between the routing data and the quality notification data, wherein the supervised ML model is trained using a training dataset and a testing dataset, the testing dataset is used to evaluate accuracy of predictions by the supervised ML model.

5. The system of claim 1, wherein the supervised ML model is a gradient-boosting decision tree model.

6. The system of claim 1, wherein the at least one processor is further configured to:
determine, via the supervised ML model, one or more causes of quality issues associated with the at least one causal asset; and
display, on the user interface, the one or more causes of the quality issues associated with the at least one causal asset, wherein the one or more causes include at least one of:
a number of defects associated with at least one product of the plurality of products exceeds an acceptable threshold, and
a deviation in color of the at least one product is greater than an acceptable deviation.

7. The system of claim 1, wherein the quality notification data indicates inspection results associated with the plurality of products, and the inspection results include binary quality outcomes associated with each of the plurality of products.

8. The system of claim 1, wherein the one or more corrective actions include at least one of adjustment in asset settings, modification in process parameters, and optimization of raw material properties.

9. The system of claim 1, wherein the at least one processor is further configured to display, on the user interface, one or more key performance indicators (KPIs) associated with the plurality of processes.

10. The system of claim 1, wherein the supervised ML model uses perturbation importance to evaluate sensitivity of each feature associated with the routing data and the quality notification data to identify the at least one causal asset.

11. A method, comprising:
receiving routing data and quality notification data associated with a plurality of products, wherein the routing data indicates flow of raw material through a plurality of assets and a plurality of processes to manufacture the plurality of products in a flexible manufacturing environment, wherein the quality notification data indicates whether the plurality of products satisfies a predetermined quality standard;
correlating, via a supervised machine learning (ML) model, the routing data and the quality notification data associated with each of the plurality of products;
identifying, via the supervised ML model, at least one causal asset from the plurality of assets based on the correlation of the routing data and the quality notification data;
generating, via the supervised ML model, a first recommendation including one or more corrective actions associated with the at least one causal asset from the plurality of assets; and
displaying, on a user interface of a display device, the first recommendation including the one or more corrective actions associated with the at least one causal asset.

12. The method of claim 11, further comprising:
identifying, via the supervised ML model, at least one causal process from the plurality of processes based on the correlation of the routing data and the quality notification data;
generating, via the supervised ML model, a second recommendation including one or more corrective actions associated with the at least one causal process from the plurality of processes; and
displaying, on the user interface, the second recommendation including the one or more corrective actions associated with the at least one causal process.

13. The method of claim 11, further comprising training the supervised ML model based on a relationship between the routing data and the quality notification data, wherein the supervised ML model is trained using a training dataset and a testing dataset, the testing dataset is used to evaluate accuracy of predictions by the supervised ML model.

14. The method of claim 11, wherein the supervised ML model is a gradient-boosting decision tree model.

15. The method of claim 11, further comprising:
determining, via the supervised ML model, one or more causes of quality issues associated with the at least one causal asset; and
displaying, on the user interface, the one or more causes of the quality issues associated with the at least one causal asset, wherein the one or more causes include at least one of:
a number of defects associated with at least one product of the plurality of products exceeds an acceptable threshold, and
a deviation in color of the at least one product is greater than an acceptable deviation.

16. The method of claim 11, wherein the quality notification data indicates inspection results associated with the plurality of products, and the inspection results include binary quality outcomes associated with each of the plurality of products.

17. The method of claim 11, wherein the one or more corrective actions include at least one of adjustment in asset settings, modification in process parameters, and optimization of raw material properties.

18. The method of claim 11, further comprising displaying, on the user interface, one or more key performance indicators (KPIs) associated with the plurality of processes.

19. The method of claim 11, wherein the supervised ML model uses perturbation importance to evaluate sensitivity of each feature associated with the routing data and the quality notification data to identify the at least one causal asset.

20. A non-transitory computer-readable medium having instructions stored thereon that, when executed by at least one processor, cause the at least one processor to perform operations comprising:
receiving routing data and quality notification data associated with a plurality of products, wherein the routing data indicates flow of raw material through a plurality of assets and a plurality of processes to manufacture the plurality of products in a flexible manufacturing environment, wherein the quality notification data indicates whether the plurality of products satisfies a predetermined quality standard;
correlating, via a supervised machine learning (ML) model, the routing data and the quality notification data associated with each of the plurality of products;
identifying, via the supervised ML model, at least one causal asset from the plurality of assets based on the correlation of the routing data and the quality notification data;
generating, via the supervised ML model, a first recommendation including one or more corrective actions associated with the at least one causal asset from the plurality of assets; and
displaying, on a user interface of a display device, the first recommendation including the one or more corrective actions associated with the at least one causal asset.
